(19) United States
(12) Patent Application Publication
(10) Pub. No.: US 2008/0305272 A1
(43) Pub. Date: Dec. 11, 2008

(54) Method for the Realisation of a Filtering Separator Comprising a Nanofibre on a Substrate with Filtering Properties

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., Porto Mantovano, Mantova (IT)

(21) Appl. No.: 12/095,823

(22) PCT Filed: Oct. 13, 2006
(86) PCT No.: PCT/EP2006/009952

§ 371 Date: Jun. 2, 2008

(30) Foreign Application Priority Data
Dec. 13, 2005 (IT) RE2005A000140

(51) Int. Cl. B05D 1/06

(52) U.S. Cl. 427/466

(57) ABSTRACT

A method for the realisation of a filtering separator (10) comprising a nanofibre layer (1) placed on a substrate (2) with filtering properties, said method comprising the following operating steps: enrichment of a substrate (2) having filtering properties with an electrically conductive material; prearranging a liquid polymeric substance (3nside a container (4) placed a distance from said substrate (2) and provided with a dispensing nozzle (5); application of a voltage difference between a first electrode (6), which is placed in contact with said liquid polymeric substance (3), and said enriched substrate (2), which acts as a second electrode so to create an electric field which drives a jet of liquid polymeric substance (3) exiting from said dispensing nozzle (5) towards the enriched substrate (2), to form on the same a network of solid polymeric fibres with nanometric dimensions.

### TECHNICAL FIELD

The present invention refers, in general, to a method for the realisation of a filtering separator.

More in particular, the present invention refers to a method for the realisation of a filtering separator which comprises a nanofibre layer associated with a support substrate having filtering properties.

Generally, nanofibres are intended as all fibres with diameters less than one micron.

As is known, the fibres with diameters less than one micron possess, load losses being equal, a greater filtering efficiency with respect to the fibres of greater dimensions.

For this reason, they are especially used in the field of fluid filtration, in various sectors of the art, as for example in the automotive sector.

In particular, nanofibres of polymeric material are presently used for the construction of filtering separators employed for the filtration of air in internal combustion engines.

### BACKGROUND ART

In this type of application, nanofibres are made in polymeric material with diameters generally less than 0.5 microns; the filtering layers of non-woven fabric are made of these nanofibres, with different size mesh according to the specific needs.

In most cases, said filtering layers are very thin, with thickness of a few superimposed nanofibres, thereby obtaining a high filtering efficiency with very small load losses.

Due to such limited thickness, generally less than one micron, the filtering layers obtained with polymeric nanofibres possess very limited mechanical characteristics, normally insufficient to support the stress due to its own weight and those due to subsequent handling.

For this reason, the nanofibre filtering layers are usually set down on an appropriate support substrate, which must be permeable to the fluid to be filtered, and must possess suitable mechanical characteristics for the production of resistant and reliable filtering separators.

Generally, these substrates are made with a material of the type conventionally used in the field of fluid filtration, as for example a cellulose sheet or a mat of polymeric microfibres.

The realisation of a nanofibre layer on a similar support structure is usually obtained starting with a liquid polymeric substance, typically a polymeric-based liquid solution or a polymer in melted state, by means of process commonly known as electrospinning.

According to such process, the liquid polymeric substance is poured into a container equipped with a dispensing nozzle having an opening with capillary dimensions.

Said container is associated with a first electrode which is placed in contact with the liquid polymeric substance, and a collector of conductive material, typically a copper or aluminium plate, which is placed at a distance from the dispensing nozzle to act as a second electrode. The support substrate is placed between the dispensing nozzle and the conductive material collector.

The process of electrospinning foresees applying a very high voltage (around 20,000 V) to the first electrode, thereby generating a high potential electric field which drives or transmits a jet of liquid polymeric substance, exiting from the dispensing nozzle, towards the conductive material collector, which is usually at ground potential.

The generation of said electric field is made possible by the fact that the support substrate, while generally being realised in materials with substantially dielectric behaviour, is not a complete dielectric capable of electrically insulating the collector.

In this manner, during its travel through the air, the liquid polymeric substance dries or solidifies, assuming the form of a network of solid fibres of nanometric dimensions which progressively collect on the support substrate, forming the desired filtering layer.

One drawback of this process lies in the fact that the support substrate inevitably creates a disturbance in the generated electric field, which may be responsible for an incorrect distribution of the nanofibres on the substrate itself, reducing the efficiency and reliability of the obtainable filtering layer.

A further drawback lies in the fact that the presence of a conductive material collector involves a substantial complication in the equipment used for the realisation of the present process, with resulting relatively high facility and production costs.

### DISCLOSURE OF INVENTION

Object of the present invention is that of overcoming the mentioned drawbacks of the prior art in the context of a simple, rational solution with limited costs.

Such object is attained by the invention as characterised in the claims.

Overall, the invention foresees enriching the support substrate with a material with conductive properties, and to directly use the substrate thus enriched as collector in the electrospinning process.

### BRIEF DESCRIPTION OF DRAWINGS

Further characteristics and advantages in the invention will be evident from the reading of the following description provided as exemplifying and not limiting, with the aid of the figures illustrated in the attached tables, wherein:

FIG. 1 schematically shows equipment for carrying out the present method.

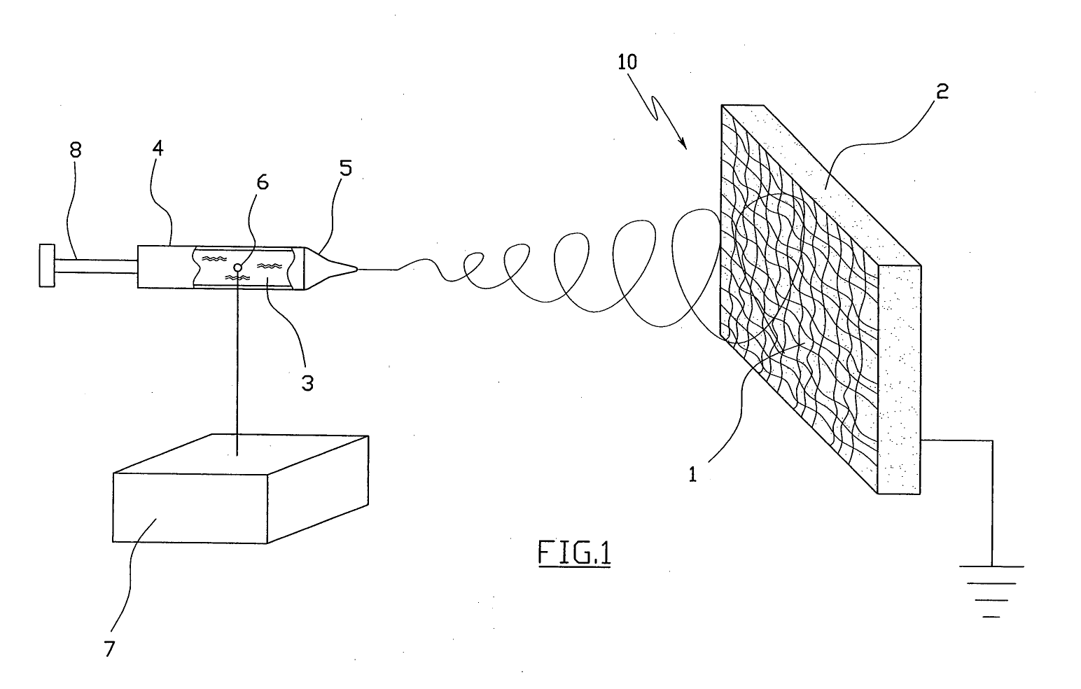

### BEST MODE FOR CARRYING THE INVENTION

The method which is object of the present invention concerns the realisation of a composite filtering separator 10 of the type comprising a layer 1 of polymeric nanofibres, placed on top of a support substrate 2 having filtering properties.

The nanofibres preferably have diameters less of than 0.5 microns, and are deposited on the substrate 2 so to form a very thin network, whose mesh may have different dimensions according to the applications.

The nanofibre layer 1 placed upon the support substrate 2 has the property of considerably increasing the efficiency of the filtering separator 10, with a very small increase in the load losses.

The support substrate 2 is considerably thicker with respect to the nanofibre substrate 1, and has improved mechanical characteristics. Said substrate 2 has the function of supporting the nanofibre layer 1, and is realised so to be subsequently worked, for example shaped or pleated, to make the filtering separator 10 suitable for various applications in the usual filtration facilities.

In particular, the invention concerns the realisation of a composite filtering separator 10, wherein said support substrate 2 is composed of a material which substantially behaves as a dielectric.

Preferably, said substrate 2 is composed of a network of fibres of greater size than the nanofibres, for example a cellulose sheet, a mat of polymeric microfibres obtained by means of a “melt-blown” or “spun-bonded” process, or else by a layer of fabric material.

Possibly, the material forming the substrate 2 may be homogeneous to that of the nanofibres which are deposited on it.

To realise the nanofibre layer 1 on a similar support substrate 2, the method which is object of the present invention foresees the enrichment of said substrate 2 with an electrically conductive material.

In particular, for enriching the support substrate 2, any process is intended which is capable of closely and inseparably uniting a conductive material to said dielectric material substrate 2, so to form a single body with both filtering and conductive properties.

According to a first embodiment of the invention, the enrichment of the support substrate 2 is obtained by means of the addition of an appropriate conductive material to the raw material used for the manufacture of the substrate 2 itself.

For example, in the case wherein said substrate 2 is made starting from a polymeric-based liquid, as occurs in the “melt-blown” or “spun-bonded” process, the conductive material is directly mixed with said polymeric-based liquid so that with the mixture obtained a homogeneous mat is made of microfibres having conductive properties. Preferably, the conductive material is added in the form of solid powders with nanometric dimensions, for example graphite particles.

According to an alternative embodiment of the invention, the enrichment of the support substrate 2 is obtained by means of the application of an appropriate conductive material, after the manufacture of the substrate 2 itself.

For example, it is possible to subject the support substrate 2 to a surface treatment by means of a dry process which employs cold plasma technology.

The cold plasma is produced by applying a high potential electric field to a low pressure gas, until the so-called flash discharge is obtained, i.e. a passage of electricity accompanied by intense emissions of reactive particles (electrons, atoms, molecules, ions and radicals) and light radiations (in visible and ultraviolet form).

The material to be treated is exposed to a substantial bombardment by these emissions, which have the capacity of modifying the chemical and physical properties of the treated surfaces, to a maximum depth generally not greater than tens of nanometres.

In particular, the interaction of cold plasma with the surfaces to be treated may lead to different modifications according to the gas used and the adopted operating conditions, including the insertion of atoms or entire chemical groups in the treated areas.

In the context of the present invention, the use is foreseen of cold plasma technology for the treatment of a support substrate 2, preferably of the type realised in polymeric material, so to obtain the insertion of atoms or chemical groups of materials with conductive properties.

Alternatively, it is possible to employ different processes, as that which soaks the support substrate 2 with a liquid substance based on a conductive material, for example by means of immersion in appropriate baths, and therefore fix said liquid substance to the substrate 2 itself, for example by means of a drying process.

After the enrichment, the method foresees the use of said enriched substrate 2 as collector in a normal electrospinning process.

In detail, the method foresees the preparation of a liquid polymeric substance 3, for example a polymeric-based liquid solution or a melted polymer, which is poured inside an appropriate container 4.

Said container 4 is placed at a distance from the enriched substrate 2, and is provided with a dispensing nozzle 5 equipped with an opening having preferably capillary dimensions.

Preferably, the intervening distance between the end of the dispensing nozzle 5 and said enriched substrate 2 is comprised between 10 and 30 centimetres.

The container 4 is associated with a first electrode 6, which is placed in direct contact with the liquid polymeric substance 3 and is connected to a voltage generator 7.

A second electrode is formed by the enriched substrate 2, which is preferably placed at ground potential.

At this point, the generator 7 is activated, so to apply a very high electric voltage (about 20,000 V) to the first electrode 6.

The voltage difference between the first electrode 6 and the enriched substrate 2 generates a high potential electric field which drives (or transmits) a jet of liquid polymeric substance 3, exiting from the dispensing nozzle 5, towards the enriched substrate 2.

During the course travelled by said jet, the liquid polymeric substance 3 dries or solidifies, assuming the form of a network of long, solid fibres of nanometric dimensions, which collect directly on the enriched substrate 2.

Regulating the viscosity of the liquid polymeric substance 3, the applied voltage and the distance between the dispensing nozzle 5 and the substrate 2, it is possible to realise nanofibre networks with variable solid/void ratio and monodispersed dimensional distribution with mean comprised between tens of nanometres and a few microns.

In particular, in order to regulate the quantity of liquid polymeric substance 3 exiting from the dispensing nozzle 5, use is foreseen of a mechanical pump 8 associated with the container, for example the use of a syringe pump.

1. Method for the realisation of a filtering separator (10) comprising a nanofibre layer (1) placed on a substrate (2) having filtering properties, characterised in that it comprises the following operating steps:
enriching a substrate (2) having filtering properties with an electrically conductive material,
prearranging a liquid polymeric substance (3) inside a container (4) placed at a distance from said substrate (2), and provided with a dispensing nozzle (5),
application of a voltage difference between a first electrode (6), which is placed in contact with said liquid polymeric substance (3) and said enriched substrate (2), which acts as a second electrode, so to create an electric field which transmits a jet of liquid polymeric substance (3) exiting from said dispensing nozzle (5) towards the enriched substrate (2), to form on the same a network of solid polymeric fibres with nanometric dimensions.

2. Method according to claim 1, characterised in that said enrichment of the substrate (2) is obtained by means of the addition of an electrically conductive material to the raw materials used for the manufacture of the substrate (2) itself.

3. Method according to claim 2, characterised in that said substrate (2) is realised starting from a polymeric-based liquid, and the electrically conductive material is directly mixed with said polymeric-based liquid.

4. Method according to claim 2, characterised in that said electrically conductive material is in the form of solid powders.

5. Method according to claim 4, characterised in that said solid powders of electrically conductive material have nanometric dimensions.

6. Method according to claim 4, characterised in that said solid powders of electrically conductive material comprise graphite particles.

7. Method according to claim 1, characterised in that said enrichment of the substrate (2) is obtained by means of the application of an electrically conductive material, after the realisation of the substrate (2) itself.

8. Method according to claim 7, characterised in that said enrichment of the substrate (2) is obtained by means of the dry insertion of particles of electrically conductive material, inside the constituent material of the substrate (2) itself.

9. Method according to claim 8, characterised in that said insertion occurs by means of exposure to a cold plasma.

10. Method according to claim 7, characterised in that said substrate (2) enrichment foresees soaking the substrate (2) with a liquid substance based on conductive material, and to fix said liquid substance to the substrate (2) itself.

11. Method according to claim 1, characterised in that said liquid polymeric substance (3) exiting from the dispensing nozzle (5) is a polymeric-based liquid solution.

12. Method according to claim 1, characterised in that said liquid polymeric substance (3) exiting from the dispensing nozzle (5) is a polymer in melted state.

13. Method according to claim 1, characterised in that it foresees controlling the quantity of liquid polymeric substance (3) exiting the dispensing nozzle by means of mechanical means (8).

14. Method according to claim 13, characterised in that said mechanical means comprise a syringe pump (8) associated with the container (4) which contains the liquid polymeric substance (3).

15. Method according to claim 1, characterised in that said dispensing nozzle (5) is provided with an exit opening of capillary dimensions.

16. Method according to claim 1, characterised in that said dispensing nozzle (5) is placed at a distance from the substrate (2) comprised between 10 and 30 centimetres.
